(19) United States
(12) Patent Application Publication
(10) Pub. No.: US 2014/0351208 A1
(43) Pub. Date: Nov. 27, 2014

(54) STORAGE SYSTEM DEVICE MANAGEMENT

(71) Applicants: Aaron L. Jenkins, Tomball, TX (US); Paul Miller, Houston, TX (US); Chiung-Sheng Wu, The Woodlands, TX (US); Balaji Natrajan, Spring, TX (US)

(72) Inventors: Aaron L. Jenkins, Tomball, TX (US); Paul Miller, Houston, TX (US); Chiung-Sheng Wu, The Woodlands, TX (US); Balaji Natrajan, Spring, TX (US)

(21) Appl. No.: 14/363,537

(22) PCT Filed: Jan. 25, 2012
(86) PCT No.: PCT/US2012/022477

§ 371 Date: Jun. 6, 2014

(51) Int. Cl. G06F 17/30

(52) U.S. Cl. CPC G06F 17/30575
USPC 707/610

(57) ABSTRACT

This document describes, in various implementations, features related to receiving, at a storage system that includes a storage volume and a plurality of storage devices that operate separately from the storage volume, read requests directed to data stored on the storage volume. The document also describes replicating certain data stored on the storage volume to the storage devices such that read requests associated with the certain data are fulfilled either by the storage volume or by the storage devices. The document also describes determining first usage information that is indicative of actual or expected usage of the storage system at a first time, and powering down at least one of the storage devices based on the first usage information.

### BACKGROUND

Modern storage systems often use a storage volume to organize and manage information. The storage volume is a logical entity representing a virtual container for data or an amount of space reserved for data. While storage volumes can be stored on a single storage device, they do not necessarily represent a single device. Typically, one or more portions of a storage volume are mapped to one or more physical storage devices.

Storage systems in certain environments may experience fluctuations in workload, e.g., based on fluctuations in usage of the applications that access data stored on the storage systems. Various applications and their corresponding storage systems may experience different workloads based on the time of day, day of week, or other similar timing cycles. For example, an enterprise application that primarily serves users in a particular geographic area may demonstrate peak usage during normal working hours, and may demonstrate off-peak usage outside of normal working hours, such as nights and weekends. Such fluctuations may be cyclic in nature, and may be more or less predictable over time in certain systems.

In addition to cyclic workload fluctuations, non-cyclic fluctuations may also occur, e.g., in response to a non-recurring or a randomly recurring event. For example, a news server may experience a higher level of requests than normal for a particular breaking news story following the occurrence that is described in the story.

### BRIEF DESCRIPTION OF THE DRAWINGS

FIG. 1 shows an example of an environment that includes an application accessing a storage system over a network.

FIG. 2 shows a conceptual diagram of data stored on a storage volume and performance assist drives.

FIG. 3 shows an example of components included in a controller.

FIG. 4 shows an example flow diagram of a process for powering down performance assist drives.

FIG. 5 shows an example flow diagram of a process for powering down and reactivating performance assist drives.

### DETAILED DESCRIPTION

Storage systems are typically designed to provide acceptable performance during expected peak usage periods, e.g., by provisioning an appropriate number of storage devices in a storage volume to handle the load on the system during those periods. For example, a particular storage volume may be designed to include an appropriate number of storage devices, operating at or near full utilization during a peak usage period, to provide acceptable performance during the peak usage period. A result of such a design is that some of the storage devices may be underutilized during off-peak usage periods. For example, some or all of the apportioned storage devices may operate at less than full utilization during off-peak hours, such as on nights or weekends. Although such a storage system may be able to provide the desired level of performance during both peak and off-peak usage periods, the underutilization of the storage devices during off-peak usage periods may result in inefficiencies, e.g., as measured by the storage system's power-to-usage effectiveness (PUE) ratio.

According to the techniques described here, a storage system may include a primary storage volume as described above, and may also include a varying number of active performance assist drives, which operate separately from the primary storage volume. The number of performance assist drives that are active versus inactive at a particular time may be dependent on the actual or expected load on the system, as well as the desired performance level of the storage system. In other words, a certain number of the performance assist drives may be powered down during periods of relatively lower system usage, assuming that the storage volume and the remaining active performance assist drives in the storage system can provide a desired level of performance during those periods.

The performance assist drives may include replicated copies of certain data (e.g., often requested data) that is stored on the primary storage volume, and may therefore be used to satisfy read requests of such data, which may effectively distribute the system load across additional storage devices. For example, a storage array controller may intelligently route data requests for the often requested data to either the primary storage volume or to one of the performance assist drives based on one or more factors, such as queue depth, input/output (I/O) response times, including average or worst-case I/O response times, and the like. During periods of lower system usage, fewer performance assist drives may be activated, thereby reducing the resource consumption of the overall storage system.

In an example implementation, a storage system may include a primary storage volume, which may be distributed across a number of storage devices, and a number of performance assist drives, which operate outside the context of the primary storage volume. A certain number of the performance assist drives may be provisioned as active during periods of relatively higher usage to achieve a desired performance of the storage system during such periods. Then during periods of relatively lower usage, the storage system may selectively deactivate and/or power down one or more of the performance assist drives. In such a manner, the storage system may provide a desired performance level during both peak and off-peak usage periods, and may also limit the number of active storage devices that are being used by the storage system to achieve the desired performance level. By limiting the number of active storage devices that are being used by the storage system during relatively lower usage periods, the system as a whole may operate more efficiently while still maintaining the ability to achieve a desired level of performance.

As one example of possible power savings utilizing the techniques described here, consider an application that uses eight storage devices to ensure acceptable I/O response times during peak usage, but only four storage devices during off-peak times. If such an application's peak window supports an example environment for fifty hours per week (ten hours per day and five days per week), then powering down four storage devices during the off-peak times results in a 35% reduction in power consumed by the devices.

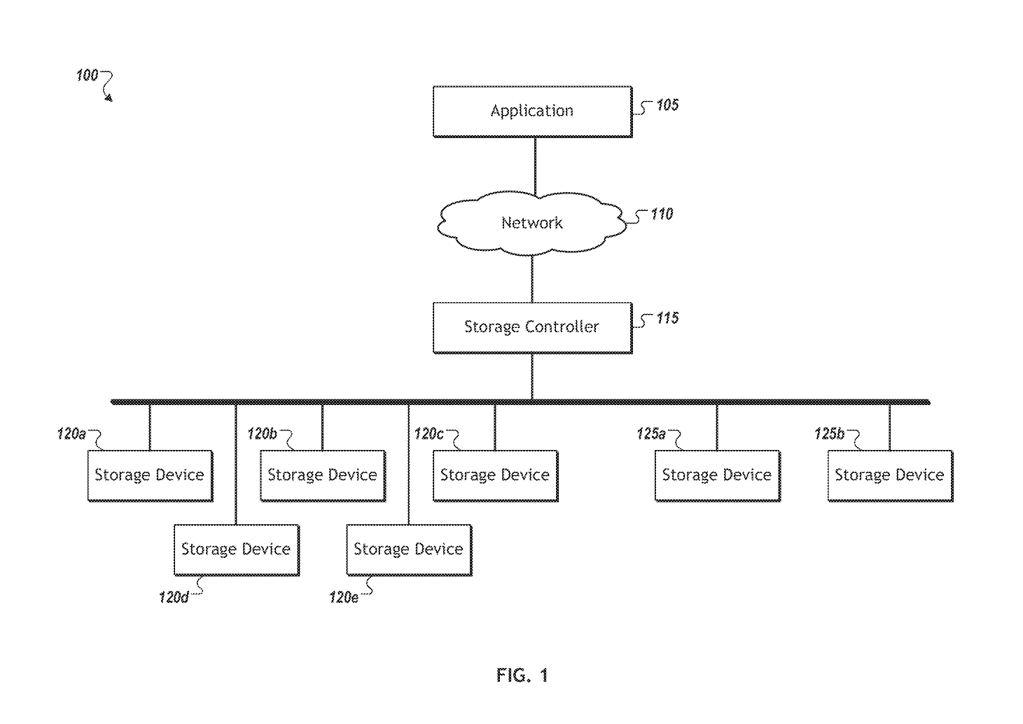

FIG. 1 shows an example of an environment 100 that includes an application 105 accessing a storage system over a network 110. The storage system may include one or more storage controllers and a number of storage devices that are used to store data that is accessible by the application 105. In some implementations, application 105 may execute on one or more servers (not shown) that are accessible by a number of clients.

In the example environment 100, the storage system includes a storage controller 115, and a total of seven storage devices that are provisioned into two different groups. Storage devices 120a, 120b, 120c, 120d, and 120e are provisioned as a primary storage volume. Storage devices 125a and 125b are provisioned as performance assist drives. In the example, a total of seven storage devices are included in the storage system, but it should be understood that the techniques described here may be applied to a storage system that includes any appropriate number of storage devices. In addition, different numbers and/or ratios of storage devices may be provisioned for use as the primary storage volume and as performance assist drives, in accordance with various implementations.

In use, storage devices 120a through 120e may operate as a typical primary storage volume. For example, the primary storage volume may be configured to provide a desired level of redundancy and performance, such as in any appropriate Redundant Array of Independent Disks (RAID) configuration that satisfies the particular system requirements. Incoming input/output (I/O) requests received by the storage controller 115 from application 105 may be serviced by one or more of the storage devices operating as part of the primary storage volume, and the storage controller 115 may respond appropriately, such as by providing requested data back to the application 105 over network 110.

The storage system may also include a number of storage devices, e.g., storage devices 125a and 125b, that operate outside the context of the primary storage volume to provide additional performance. These storage devices may be referred to as performance assist drives (PADs), and may store replicated copies of certain data that is stored on the primary storage volume. For example, the certain data that is stored on the primary storage volume and replicated to the PADs may include data that is accessed more often than other data, such that read requests for the often-accessed data may be distributed to any of a number of storage devices on which the data is stored. When a read request for such data is received by the storage controller 115, the controller may determine which of the storage devices should be used to fulfill the request, e.g., based on the current load on the various storage devices that store the certain data.

In some implementations, the read request may be fulfilled by the appropriate storage device or devices in the primary storage volume by default, but may alternatively be routed to one of the PADs if the controller determines that the storage device in the primary storage volume is overloaded or is otherwise “busy”. Other request fulfillment schemes may also be implemented, such as routing the requests to one of the PADs by default and only servicing requests using the primary storage volume if the PADs are overloaded, or by using any other appropriate request fulfillment scheme. Regardless of the particular implementation, read requests from application 105 for the replicated data may be fulfilled either by the storage volume or by one of the PADs.

According to the techniques described here, one or more of the PADs may be selectively powered down when the storage system can achieve a desired performance using fewer than all of the PADs. For example, in environment 100, if the storage volume and a single PAD may provide a desired performance (e.g., I/O response times in an acceptable range), then either of the PADs may be powered down, thereby reducing the power consumed by the storage system. Similarly, in storage systems that include greater numbers of PADs, the storage system may selectively power down an appropriate number of PADs such that the remaining active PADs, in conjunction with the primary storage volume, can provide a desired level of performance.

In the example environment 100, storage controller 115 may determine usage information that is indicative of actual or expected usage at a particular time, and may power down one or more of the PADs based on the determined usage information. In the case of usage information that is indicative of actual usage, the storage system may monitor (e.g., in real-time or near real-time) certain metrics that are indicative of actual usage, such as by monitoring queue depth, I/O response times, including average and/or worst-case response times, or other similar metrics. Such usage information may then be analyzed to determine whether any of the PADs may be powered down while still achieving a desired performance metric.

In some implementations, the usage information may include I/O response times that are associated with accesses of the storage system. In such implementations, the storage controller may monitor the I/O response times associated with accesses of the storage system, and may compare the actual I/O response times to a desired I/O response time. Then, if the actual I/O response times are faster than the desired I/O response time, the storage controller may also determine whether the desired I/O response time is achievable using fewer PADs than are active. For example, the storage controller may attribute an incremental response time difference to each incremental active PAD, and may determine whether the desired I/O response time metric may be achieved using fewer active PADs. If so, then the storage controller may cause one or more of the PADs to be powered down. For example, the storage controller may cause any PADs that are extraneous to achieving the desired I/O response time to be powered down. In some implementations, other appropriate metrics may be monitored and compared to a desired metric, either alternatively or in addition to the example described above.

In the case of usage information that is indicative of expected usage, the storage system may access historical records of usage over time, and may predict expected usage levels at a particular date and time based on observed usage trends. For example, if system usage over time is observed to typically be lowest on weekend mornings, it can be predicted that system usage will also be low on an upcoming weekend morning, and the storage system may power down an appropriate number of PADs to reduce power consumption while still maintaining a desired level of performance.

In another case of usage information that is indicative of expected usage, the storage system may access a set of rules defined in advance by a system administrator. For example, the set of rules may include a schedule that defines the number of PADs that should be active at any particular time. The schedule may be defined based on historical usage analysis (similarly to the predicted usage levels described above). The schedule may alternatively or additionally be defined based on known or predictable future events that may affect usage at a particular time. For example, in a sales system that is preparing for the launch of a much-anticipated product release, a system administrator may schedule an increased number of active PADs in advance of the product release and for a period of expected higher usage following the release.

In some implementations, usage information that corresponds to both actual and expected usage may be used to determine how many PADs should be active at a particular time, and correspondingly, how many PADs may be powered down. For example, the storage system may generally follow a predefined schedule based on expected usage, but may adjust the number of PADs that are activated according to real-time usage information. As another example, actual usage information may serve as the primary driver for PAD activation or deactivation, but may be supplemented with expected usage information to ensure efficient transitions between PAD activations and deactivations.

After any of the PADs has been powered down as described above, the storage system may continue to monitor usage information that is indicative of actual or expected usage, and may subsequently reactivate one or more PADs that were previously powered down. For example, when usage levels increase or are expected to increase, the system may reactivate a number of PADs that will allow the system to achieve a desired performance metric. Continuing with the I/O response time example above, if the observed I/O response time is longer than, or is expected to increase to be longer than, the desired I/O response time, the storage controller may reactivate one or more previously deactivated PADs to achieve the desired I/O response time.

Reactivating a previously deactivated PAD may include powering up the storage device, and replicating the often-used data in the storage volume to the device. The often-used data in the storage may be replicated from the storage volume, or from one or more of the other PADs. For example, replicating the often-used data in the storage volume may involve a full replication of an active PAD to the PAD that is being reactivated.

In some implementations, the storage system may proactively prepare one or more of the PADs for powering down in advance of the actual powering down, such as by storing certain information about the state of the PAD that is being powered down. Such information may allow the PAD to be reactivated more efficiently than the full replication approach described above. For example, a timestamp or other indicator of the state of the PAD prior to powering down may be stored either on the PAD itself, on one of the other PADs, or in another location that is accessible by the storage controller. This indicator may subsequently be used during power up of the PAD to provide more efficient reactivation.

For example, before bringing a previously deactivated PAD back online, the storage controller may determine, based on the indicator, which data should be replicated to the PAD. In this example, the storage controller may identify, using the indicator, the state of the data before the PAD was powered down, and may only replicate data that was changed after the PAD was powered down. In such a manner, the PAD can be powered up and brought back online in less time than if the entirety of the PAD data was to be replicated.

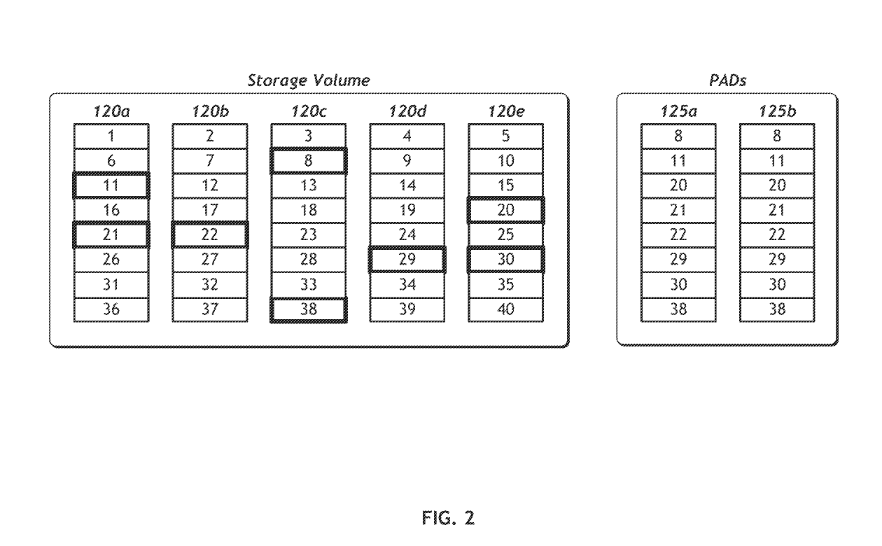

FIG. 2 shows a conceptual diagram of data stored on a storage volume and performance assist drives. The diagram illustrates a simplified example in which the numbered rectangles 1-40 represent regions of a logical storage volume, which is spread across multiple storage devices 120a through 120e. Frequently accessed regions, as represented by the rectangles having thicker borders, have been replicated to each of the storage devices 125a and 125b that are provisioned as PADs. In this example, regions 8, 11, 20, 21, 22, 29, 30, and 38 represent regions containing frequently accessed data. It should be understood that, typical storage systems may include thousands of regions, and that each region may be much larger than the “stripe” size on an individual drive, so a single region may actually span more than one drive of the storage volume.

Since the data contained in region 22 has been replicated to each of the PADs, a read request for data in region 22 could be serviced by storage device 120b, which is provisioned as part of the storage volume, or by either of storage devices 125a or 125b. This selective mirroring of data may improve system response times, e.g., by reducing the average drive queue length when compared to a typical storage system that does not utilize PADs. According to the techniques described here, one or more of the PADs may be selectively activated or deactivated, depending on actual or expected system load and the desired performance characteristics of the storage system.

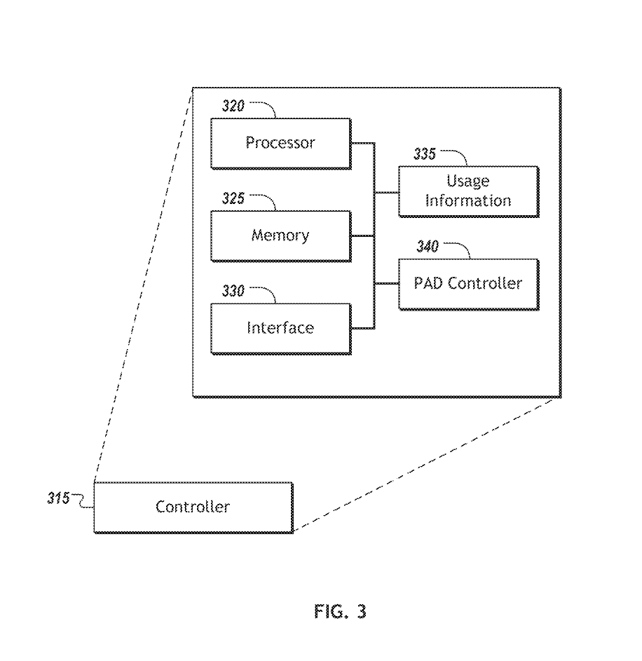

FIG. 3 shows an example of components included in a controller 315. Controller 315 may, in some implementations, be used to perform portions or all of the functionality described above with respect to storage controller 115 of FIG. 1. It should be understood that the components shown here are for illustrative purposes, and that different or additional components may be included in controller 315 to perform the functionality as described.

Processor 320 may be configured to process instructions for execution by the controller 315. The instructions may be stored on a tangible computer-readable storage medium, such as in memory 325 or on a separate storage device (not shown), or on any other type of volatile or non-volatile memory that stores instructions to cause a programmable processor to perform the techniques described herein. Alternatively or additionally, controller 315 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

Interface 330 may be implemented in hardware and/or software, and may be configured, for example, to receive and respond to I/O requests directed to data stored on the storage volume.

Usage information module 335 may be configured to monitor, over time, which data stored on the storage volume is being requested. Such information may be used by PAD controller module 340 to determine portions of the data stored on the storage volume that should be replicated to the PADs. Based on such information PAD controller module 340 may issue one or more appropriate commands, e.g., via interface 330, to cause the portions of the data to be replicated to the PADs.

Usage information module 335 may also be configured to determine usage information that is indicative of actual or expected usage of the storage system. For example, usage information module 335 may actively monitor (e.g., in real-time or near real-time) certain metrics that are indicative of actual usage, such as by monitoring queue depth, I/O response times, including average and/or worst-case response times, or other similar metrics. As another example, usage information module 335 may be configured to access historical records of usage over time, and may predict expected usage levels at a particular date and time based on observed usage trends. Usage information module 335 may also be configured to access a schedule that is associated with expected usage, such as a schedule that defines the number of PADs that should be active at any particular time.

Based on the usage information determined by usage information module 335, the PAD controller module 340 may cause at least one of the PADs to be powered down. For example, the usage information module 335 may monitor I/O response times associated with accesses of the storage system, and may provide the I/O response times to the PAD controller module 340. In turn, the PAD controller module 340 may compare the I/O response times to a desired I/O response time, and may determine that the desired I/O response time would be achievable using fewer active PADs. Then the PAD controller module 340 may issue one or more appropriate commands, e.g., via interface 330, to cause any extraneous PADs to be powered down.

Usage information module 335 may also be configured to determine subsequent usage information that is indicative of actual or expected usage of the storage system. As described above, such subsequent usage information may be acquired through active monitoring of various performance metrics, or by referencing stored information that is indicative of expected usage. The subsequent usage information may then be provided to the PAD controller module 340, which may reactivate at least one of the PADs that was previously powered down. For example, if the subsequent usage information indicates that more PADs will be necessary to achieve a particular desired performance metric, the PAD controller module 340 may issue one or more appropriate commands, e.g., via interface 330, to cause an appropriate number of PADs to be reactivated.

PAD controller module 340 may also be configured to control data replication to the reactivated PADs. For example, in some implementations, the PAD controller module 340 may issue appropriate commands that cause all of the data stored on one or more active PADs to be replicated to the newly reactivated PAD or PADs. In other implementations, the PAD controller module 340 may first determine metadata related to a current storage state of the newly reactivated PAD (e.g., a timestamp or other appropriate metadata that can be used to determine which data was stored on the PAD before it was powered down, and/or to determine which data has been changed since the PAD was powered down), and may issue appropriate commands that cause only portions of the data stored on one or more active PADs to be replicated to the newly reactivated PAD. For example, the PAD controller module 340 may identify a timestamp that indicates when the PAD was taken offline, and may cause only newly written data to be replicated to the PAD.

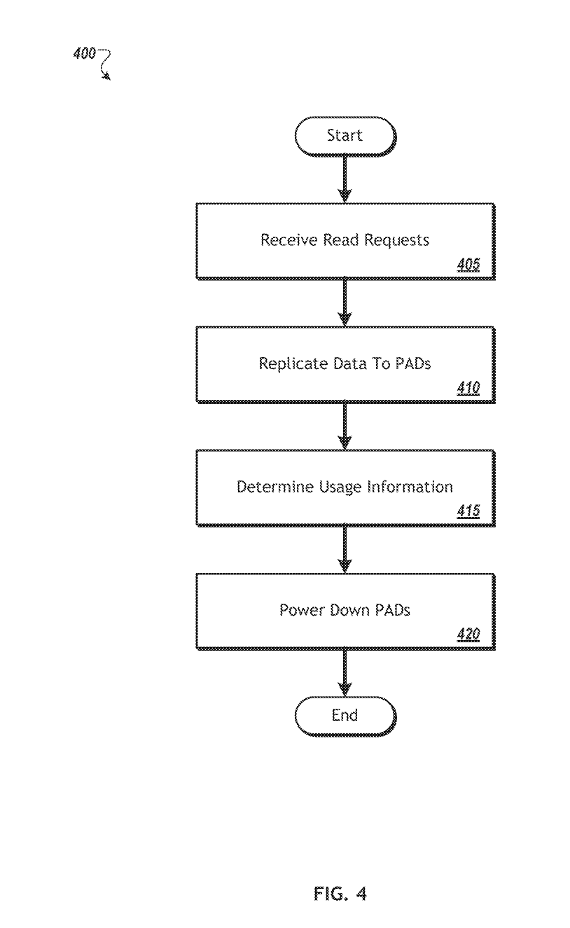

FIG. 4 shows an example flow diagram of a process 400 for powering down performance assist drives. The process 400 may be performed, for example, by a storage system such as the storage system illustrated in FIG. 1. For clarity of presentation, the description that follows uses the storage system illustrated in FIG. 1 as the basis of an example for describing the process. However, another system, or combination of systems, may be used to perform the process or various portions of the process.

Process 400 begins with block 405, in which a storage system receives read requests for data stored on a primary storage volume of the storage system. For example, the read requests may be received by a storage controller, e.g., storage controller 115, and from an application, e.g., application 105. The storage controller 115 may monitor the read requests and determine that certain of the data stored on the storage volume is requested more often than other data stored on the storage volume.

At block 410, the often accessed data is replicated to a number of active performance assist drives (PADs), which are storage devices that operate within the context of the storage system, but separately from the storage volume. The often accessed data may be replicated to each of the active PADs such that read requests associated with the often accessed data may be fulfilled either by the storage volume, or by any of the active PADs.

At block 415, the storage system determines usage information that is indicative of actual or expected usage of the storage system at a particular time. For example, storage controller 115 may monitor one or more performance metrics, such as I/O response times, queue depths, or other appropriate metrics that are indicative of actual usage. As another example, storage controller 115 may reference information that is indicative of expected usages, such as a schedule that defines a number of PADs that should be active at a particular time, or historical usage statistics that allow the storage controller to predict system usage at a particular time.

At block 420, the storage system powers down at least one of the PADs based on the usage information. For example, the usage information may include I/O response times that are associated with accesses of the storage system. In this example, the storage controller may monitor the I/O response times associated with accesses of the storage system, and may compare the actual I/O response times to a desired I/O response time for the system. If the actual I/O response times are faster than the desired I/O response time, the storage controller may also determine whether the desired I/O response time is achievable using fewer PADs than are currently active. If so, then the storage controller may cause one or more of the PADs to be powered down. In some examples, the storage controller may cause any PADs that are extraneous to achieving the desired I/O response time to be powered down. It should be understood that other appropriate metrics may be monitored, either alternatively or in addition to the I/O response time metric example described above.

Following power down of one or more of the PADs as described above, the storage system is able to achieve a desired performance metric using the storage volume and the remaining active PADs. In addition, the storage system may consume less power because one or more of the PADs is no longer being powered in the system.

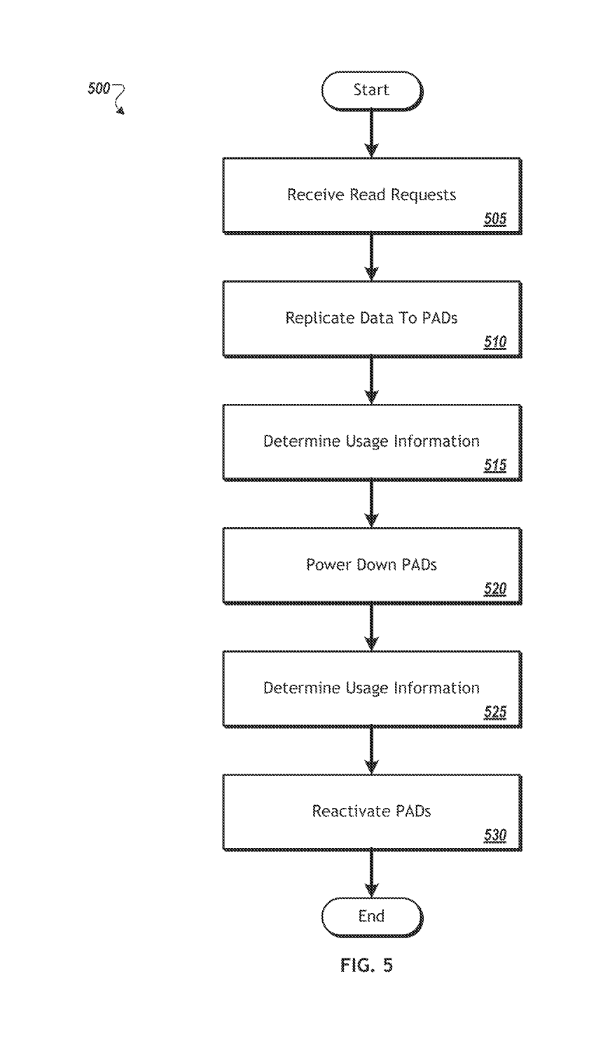

FIG. 5 shows an example flow diagram of a process 500 for powering down and reactivating performance assist drives. The process 500 may be performed, for example, by a storage system such as the storage system illustrated in FIG. 1. For clarity of presentation, the description that follows uses the storage system illustrated in FIG. 1 as the basis of an example for describing the process. However, another system, or combination of systems, may be used to perform the process or various portions of the process.

Process 500 begins with block 505. Blocks 505 through 520 operate similarly to blocks 405 through 420, respectively, of FIG. 4. For example, at block 505, a storage system receives read requests for data stored on a primary storage volume of the storage system. At block 510, the often accessed data is replicated to a number of active PADs. At block 515, the storage system determines usage information that is indicative of actual or expected usage of the storage system at a particular time. And at block 520, the storage system powers down at least one of the PADs based on the usage information.

Process 500 continues with block 525, in which the storage system determines subsequent usage information that is indicative of actual or expected usage of the storage system at a subsequent time. For example, the storage system may have powered down one or more of the PADs at 7:00 pm on a Friday evening based on actual and/or expected usage of the storage system over the weekend as being lower than during typical working hours during the week. Such usage information at 7:00 pm on Friday evening may be different than the usage information that is subsequently determined at 7:00 am on the following Monday morning, which corresponds to the start of the work week.

At block 530, the storage system reactivates, based on the subsequent usage information, at least one of the PADs that was previously powered down. Continuing with the previous example, the storage system may reactivate one or more of the PADs at 7:00 am on the following Monday in anticipation of increased system usage during the work week. For example, the storage system may power up an appropriate number of the previously powered down PADs (e.g., a number of PADs that will allow the system to achieve a desired performance metric), and may replicate the often accessed data to the newly reactivated PADs.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A method comprising:
receiving, at a storage system that includes a storage volume and a plurality of storage devices that operate separately from the storage volume, read requests directed to data stored on the storage volume;
replicating certain data stored on the storage volume to the storage devices such that read requests associated with the certain data are fulfilled either by the storage volume or by the storage devices;
determining first usage information that is indicative of actual or expected usage of the storage system at a first time; and
powering down at least one of the storage devices based on the first usage information.

2. The method of claim 1, wherein determining the first usage information comprises analyzing input/output response times associated with accesses of the storage system.

3. The method of claim 2, wherein powering down at least one of the storage devices comprises comparing the input/output response times to a desired input/output response time, determining that the desired input/output response time is achievable using fewer storage devices than are active, and powering down a number of the storage devices that are extraneous to achieving the desired input/output response time.

4. The method of claim 1, further comprising determining second usage information that is indicative of actual or expected usage of the storage system at a second time that is later than the first time, and reactivating, based on the second usage information, at least one of the storage devices that was previously powered down.

5. The method of claim 4, wherein reactivating the at least one of the storage devices comprises powering up the storage device, and replicating the certain data to the storage device.

6. The method of claim 5, wherein replicating the certain data to the storage device comprises replicating only the certain data stored on the storage volume since the storage device was powered down.

7. A system comprising:
a first plurality of storage resources provisioned as a storage volume to store data;
a second plurality of storage resources provisioned as assist drives that operate separately from the storage volume to store copies of certain of the data such that read requests associated with the certain of the data are fulfilled either by the storage volume or by one of the assist drives; and
a controller to determine a number of the assist drives that are extraneous to providing a desired performance metric associated with the read requests, and to power down the determined number of the assist drives.

8. The system of claim 7, wherein the controller compares the desired performance metric to a measured performance metric associated with the read requests to determine the number of the assist drives that are extraneous to providing the desired performance metric.

9. The system of claim 8, wherein the controller further compares, at a time after powering down the determined number of the assist drives, the desired performance metric to a subsequently measured performance metric associated with the read requests, and powers up, based on the comparison, certain of the assist drives that were powered down.

10. The system of claim 9, wherein the controller causes data stored on at least one of the assist drives that was not powered down to be replicated to the powered-up assist drives that were powered down.

11. A non-transitory computer-readable storage medium storing instructions that, when executed by a processor, cause the processor to:
receive, at a storage system that includes a storage volume and a plurality of storage devices that operate separately from the storage volume, read requests directed to data stored on the storage volume;
replicate certain data stored on the storage volume to the storage devices such that read requests associated with the certain data are fulfilled either by the storage volume or by the storage devices;
determine first usage information that is indicative of actual or expected usage of the storage system at a first time; and
power down at least one of the storage devices based on the first usage information.

12. The computer-readable storage medium of claim 11, wherein determining the first usage information comprises analyzing input/output response times associated with accesses of the storage system.

13. The computer-readable storage medium of claim 12, wherein powering down at least one of the storage devices comprises comparing the input/output response times to a desired input/output response time, determining that the desired input/output response time is achievable using fewer storage devices than are active, and powering down a number of the storage devices that are extraneous to achieving the desired input/output response time.

14. The computer-readable storage medium of claim 11, further comprising instructions that cause the processor to determine second usage information that is indicative of actual or expected usage of the storage system at a second time that is later than the first time, and reactivate, based on the second usage information, at least one of the storage devices that was previously powered down.

15. The computer-readable storage medium of claim 14, wherein reactivating the at least one of the storage devices comprises powering up the storage device, and replicating to the storage device only the certain data stored on the storage volume since the storage device was powered down.
